(19) United States
(12) Patent Application Publication
(10) Pub. No.: US 2006/0071604 A1
(43) Pub. Date: Apr. 6, 2006

(54) Vehicular lamp for nebulous weather

(75) Inventors: Ernest A. Davey JR., Salem, NH (US); Walter P. Lapatovich, Boxford, MA (US); Dana L. Caldwell, Middleton, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 10/959,937

(22) Filed: Oct. 6, 2004

(51) Int. Cl. H01J 61/20; H01J 17/20

(52) U.S. Cl. 313/639

(57) ABSTRACT

An arc discharge vehicle lamp (10) for nebulous weather comprising a body (12) defining a chamber (14) having a volume of between 0.025 to 0.035 cc and including spaced apart electrodes (16, 18) having an arc gap (20) of between 2 and 6 mm; and an arc generating and sustaining medium (21) in the chamber for developing light having a color temperature between 1800K to 2800K during operation of the lamp. A preferred arc gap is 4.2 mm. The electrodes (16 and 18) are preferably fashioned with three parts; a niobium sealing region, an intermediate region of molybdenum and a tungsten region, which protrudes into the discharge chamber.

### TECHNICAL FIELD

This invention relates generally to lamps and more particularly to a vehicle lamp for nebulous or inclement weather conditions. As used herein, nebulous refers to those conditions wherein the atmosphere contains sufficient particles to scatter normal white light, making vehicle movement somewhat hazardous by increasing glare and creating discomfort for the vehicle operator. Such conditions include, but are not limited to, rain, snow, fog, dust, smoke or fumes.

The term “vehicle” is used herein in its broadest sense and includes, without limitation, automobiles, recreational vehicles, motorcycles, snowmobiles, trains, boats, airplanes, and military vehicles especially vehicles for use under salt water.

### BACKGROUND ART

Glare caused by the entrained particles in the nebulous atmosphere often interferes with the ability to operate a vehicle safely since it can cause eyestrain and fatigue to the pilot.

The scattering of electromagnetic radiation has a complicated dependence on the size and dielectric nature of the particles. Generally, if the particles are of the appropriate size, the scattering is proportional to the frequency (or inversely proportional to the wavelength) raised to some power, often the fourth power. This strong frequency dependence suggests that, in nebulous weather conditions, lights containing strong blue spectral components will scatter more and cause more discomfort and disability glare. A recent development in the art of vehicle lighting, particularly for automotive use, has relied upon high intensity discharge lamps, which have a very strong blue component. To provide alternate lighting for the nebulous conditions that can occasionally be present, the current art utilizes filtered lamps to produce a more yellow light. Such lamps usually employ a light source having an incandescent filament of tungsten operated in a vacuum, inert or in a halogen atmosphere. The light output from such lamps is white light, which is undesirable, so that filtering is provided either on the lamp bulb itself or in a lens or covering placed in front of the lamp. This procedure means that only a fraction of the light being produced is available to provide the forward illumination.

### DISCLOSURE OF INVENTION

It is, therefore, an object of the invention to obviate the disadvantages of the prior art.

It is another object of the invention to enhance the forward lighting of vehicles in nebulous conditions.

Another object of the invention is the provision of an arc discharge lamp for providing orange “sodium” light.

These objects are accomplished, in one aspect of the invention, by the provision of an arc discharge vehicle lamp for nebulous weather comprising: a body defining a chamber and including spaced apart electrodes having an arc gap of between 2 and 6 mm; and an arc generating and sustaining medium in said chamber for developing light having a color temperature between 1800K to 2800K during operation of said lamp.

With the light being produced by the lamp in the desired range, no additional filtering is necessary and all of the light produced can be utilized. Additionally, the lamp can utilize the electronic equipment already present in a vehicle employing high intensity discharge forward lighting.

### BRIEF DESCRIPTION OF THE DRAWINGS

FIG. 1 is an elevational view of an arc discharge lamp in accordance with an embodiment of the invention; and

FIG. 2 is a cross-sectional view of a lighting apparatus employing the arc discharge lamp.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

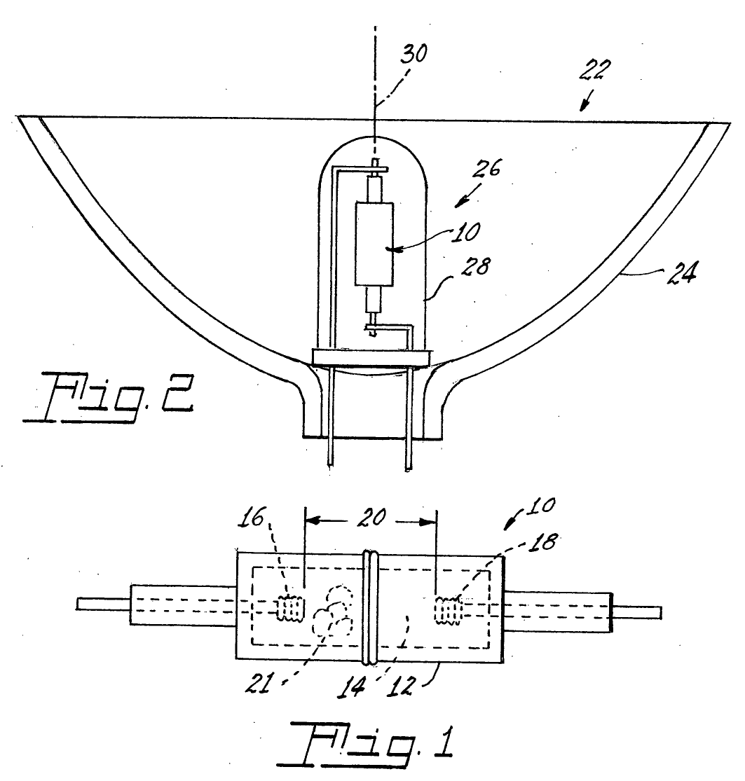

Referring now to the drawings with greater particularity, there is shown in FIG. 1 an arc discharge vehicle lamp 10 for nebulous weather comprising a body 12 defining a chamber 14 having a volume of between 0.025 to 0.035 cc and including spaced apart electrodes 16, 18 having an arc gap 20 of between 2 and 6 mm; and an arc generating and sustaining medium 21 in said chamber for developing light having a color temperature between 1800K to 2800K during operation of the lamp. A preferred arc gap is 4.2 mm. The electrodes 16 and 18 are preferably fashioned with three parts; a niobium sealing region, an intermediate region of molybdenum and a tungsten region, which protrudes into the discharge chamber. The electrodes may or may not have a coil on the tip.

The body 12 is constructed from a material selected from the group consisting essentially of polycrystalline alumina, sapphire or vitreous silica, with alumina being preferred, and can be of the form shown in U.S. Pat. No. 6,620,272. Alternatively, the body could be formed of one piece by using slip casting or die forming.

The arc generating and sustaining medium includes a gas selected from the group consisting essentially of argon and xenon and a quantity of mercury and sodium iodide. The gas is present at a cold fill temperature (i.e., 20° C.) of between 5-12 atmospheres. The quantity of mercury must be sufficient to control the voltage and preferably permit the use of the lamp on the control gear designed for operating conventional HID headlamps (e.g., 85+/−15V at 0.4 amperes). Such a quantity is between 0.010 to 0.025 mg/mm³ of Hg.

The quantity of sodium iodide is between 0.005 to 0.025 mg/mm³.

In a preferred embodiment the quantity of mercury is 0.016 mg/mm³. Additional halides can also be used. For example, a quantity of sodium-scandium iodide with a molar ratio of sodium to scandium of 7:1 can be used with the sodium iodide. Other halide additives, such as the rare-earth halides or the alkaline earth halides, might also be used to tweak the color output.

The following examples illustrate specific embodiments.

Lamp # 1 had a fill comprising 0.49 mg of mercury, 0.42 mg of sodium iodide and 8 atmospheres of xenon. In operation on commercially available electronic control gear, lamp # 1 ran t 87V and 0.44 amperes for a power consumption of 38.3 watts. The CCT was recorded at 1980K and was heavily weighted towards the yellow.

Lamp # 2 had a fill comprising 0.49 mg of mercury, 0.2 mg of sodium iodide and 0.2 mg of sodium-scandium iodide with a molar ratio of sodium to scandium of 7:1. Lamp # 2 ran at 72V and 0.47 amperes for a power consumption of 33.8 watts. The recorded CCT was 2400K. Center luminance for both lamps was recorded between 13 to 17 Cd/mm².

FIG. 2 shows a lighting apparatus 22 comprising a substantially concave reflector 24 with a light source 26 mounted in the reflector. The light source 26 comprises a transparent, hermetically sealed envelope 28 having a longitudinal axis 30 with an arc discharge vehicle lamp 10 mounted therein on the longitudinal axis 30. The envelope 28 can contain a vacuum or an inert gas and may contain a getter material to absorb any hydrogen or oxygen

The base of the light source 26 can be of any suitable design to mate with the reflector. The base of the reflector can be provided with mating connectors to interface with existing electronic control gear used to power HID headlamps.

Thus there is provided a light source for nebulous weather conditions whose primary light output is in the yellow region of the spectrum, therefore requiring no filtering and utilizing substantially all of the light output for its intended purpose

The light source will operate on the existing electronic gear already being used with HID headlamps so that additional operating expense is avoided.

While there have been shown and described what are present considered to be the preferred embodiments of the invention, it will be apparent to those skilled in the art that various changes and modifications can be made herein without departing from the scope of the invention as defined by the appended claims.

What is claimed is:

1. An arc discharge vehicle lamp for nebulous weather comprising:
a body defining a chamber and including spaced apart electrodes having an arc gap of between 2 and 6 mm; and
an arc generating and sustaining medium in said chamber for developing light having a color temperature between 1800K to 2800K during operation of said lamp.

2. The arc discharge vehicle lamp of claim 1 wherein said body is constructed from a transparent or translucent material selected from the group consisting essentially of polycrystalline alumina, sapphire or vitreous silica.

3. The arc discharge vehicle lamp of claim 1 wherein said arc generating and sustaining medium includes a gas selected from the group consisting essentially of argon and xenon and a quantity of mercury and sodium iodide.

4. The arc discharge vehicle lamp of claim 3 wherein said gas has a cold fill pressure of between 5 and 12 atmospheres.

5. The arc discharge vehicle lamp of claim 4 wherein said quantity of mercury is present in amount of between 0.010 to 0.025 mg/mm³.

6. The arc discharge vehicle lamp of claim 5 wherein said quantity of sodium iodide is between 0.005 to 0.025 mg/mm³.

7. The arc discharge vehicle lamp of claim 1 wherein said chamber has a volume between 0.025 to 0.035 cc.

8. The arc discharge vehicle lamp of claim 5 wherein said quantity of mercury is 0.016 mg/mm³.

9. The arc discharge vehicle lamp of claim 3 wherein said arc generating and sustaining medium additionally includes a quantity of sodium-scandium iodide with a molar ratio of sodium to scandium of 7:1.

10. A lighting apparatus comprising:
a substantially concave reflector;
a light source mounted with said reflector, said light source comprising a transparent or translucent envelope having a longitudinal axis with an arc discharge vehicle lamp mounted therein on said longitudinal axis, said arc discharge lamp comprising a body defining a chamber and including spaced apart electrodes having an arc gap of between 2 and 6 mm; and
an arc generating and sustaining medium in said chamber for developing light having a color temperature between 1800K to 2800K during operation of said lamp.

11. The lighting apparatus of claim 10 wherein said body is constructed from a transparent or translucent material selected from the group consisting essentially of polycrystalline alumina, sapphire or vitreous silica.

12. The lighting apparatus of claim 11 wherein said arc generating and sustaining medium includes a gas selected from the group consisting essentially of argon and xenon and a quantity of mercury and sodium iodide.
